(19) United States
(12) Patent Application Publication
(10) Pub. No.: US 2021/0229261 A1
(43) Pub. Date: Jul. 29, 2021

(54) Toolbox with Luminescent Surface

(71) Applicant: Industrias Tayg, S.L.U., Beniparrell (Valencia) (ES)

(72) Inventor: Antonio Hostalet Aunion, Beniparrell (Valencia) (ES)

(21) Appl. No.: 16/959,464

(22) PCT Filed: Jan. 22, 2019
(86) PCT No.: PCT/ES2019/070029

§ 371 Date: Jul. 1, 2020

(30) Foreign Application Priority Data
Feb. 28, 2018 (ES) U201830267

(51) Int. Cl. B25H 3/02; F21V 33/00

(52) U.S. Cl. CPC B25H 3/022; B62B 2202/48; F21V 33/0084

(57) ABSTRACT

Tool box fitted with a luminescent surface includes a first body (1) that houses a second (2), third (3) and fourth (4) body inside, and the surface of these bodies (1, 2, 3, 4) has a luminescent and reflective coating (5) that allows for these bodies to be viewed (1, 2, 3, 4) even in situations of poor visibility, and the bodies (2, 3, 4) feature a surface area whose measurements coincide with the interior area of the first body (1) to be properly housed therein.

The purpose of this specification is a toolset carry-box with a luminescent surface, whose main advantage lies in incorporating parts of its luminescent surface, which allows its user to locate it swiftly and easily, in conditions of poor visibility and/or allow other users to locate it in situations of identical visibility.

### BACKGROUND OF THE INVENTION

Currently, toolboxes or tool holders are devised as receptacles to carry work tools or other related items (such as pegs, screws or similar) that allow their user (operator) to comfortably organize all the necessary elements to correctly carry out their work properly.

The main drawback of these toolboxes is that they are usually “specialized” in various fields, thus each element requires its own box or is organized in different boxes, which invariably means that operators exit their means of transport weighed down, for example a box for machinery (for example, a drill), another for accessories (screws, plugs or similar), another for tools (hammers, screwdrivers, etc.). This implies that for the transportation of the latter, several trips must be made from the means of transport to the workplace, in order to shuttle everything necessary for the performance of the functions entrusted to the operator.

This becomes an element of risk, when these functions are performed at certain moments of low visibility, which implies that, on the one hand, the operator cannot easily locate all the elements necessary for the required tasks (meaning important time is lost in locating all the boxes needed to perform these tasks), as well as in terms of safety (knocks with these boxes or the fact they are not visible to third parties, which might lead to minor accidents).

### DESCRIPTION OF THE INVENTION

The technical issue solved by this invention is to obtain a tool holder box with a part of its surface that is luminescent in nature, making it possible for its user to locate it easily in moments of poor visibility. To achieve this, the toolset carry-box with a luminescent surface, the subject of this utility model, comprises a first body that houses in its inner section a second, third and fourth

body, where, on the surface of these bodies there is a luminescent and reflective coating that allows viewing these bodies even in situations of poor visibility, and the bodies feature a surface area whose measurements coincide with the interior area of the first body to be properly lodged therein.

Thanks to its design, the box recommended here will have several luminescent areas on its surface, in such a way that it can be located particularly at those times of the day when there is poor visibility, or on works where there is low visibility.

The box proposed here will have a non-slip surface on its upper part, which will provide greater safety, turning this area into a safe space to deposit certain objects required for the work being carried out in question, and that could cause injuries of differing kinds if they accidentally fell on the operator or another person located in the working area. Or that, due to the physical characteristics of said element, it could shatter upon contact with the ground.

The toolbox can be separated into its different bodies in such a way that the operator can lay out all those elements that are necessary to work quickly and safely. This means that the operator can carry out their tasks in a more streamlined manner, since it will limit the loss of time both in transport and in the collection of material, which will invariably result in lower labor costs that will affect the economic costs associated with the work performed.

The proposed toolbox is intended for use both with bare hands and with gloves, which allows its user to operate with or without gloves whenever they have to move or access it.

Finally, the toolbox advocated here is materialized in such a way that it can support up to a weight of 120 kilograms, which, at certain times, will allow a user weighing less than 120 kg to use it as a stool to access certain places, where they would otherwise be unable to reach, avoiding the use of step ladders.

### BRIEF DESCRIPTION OF THE FIGURES

A brief description is given below of a series of illustrations that help to obtain a deeper understanding of the invention and are expressly related to an implementation of said invention that is presented as a non-limiting example.

FIG. 1. Displays a view of the first body (1) as a component of the toolset carry-box with a luminescent surface, the subject of this utility model.

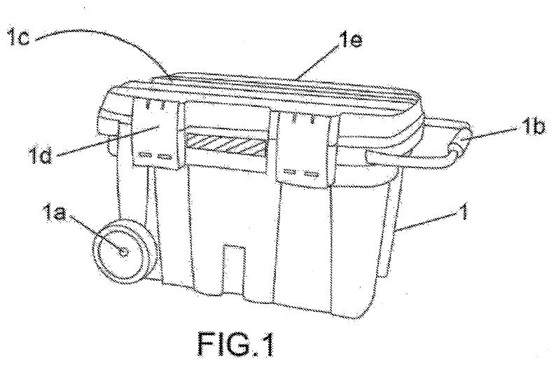

FIG. 2. Displays a view of the second body (2) as a component of the toolset carry-box with a luminescent surface.

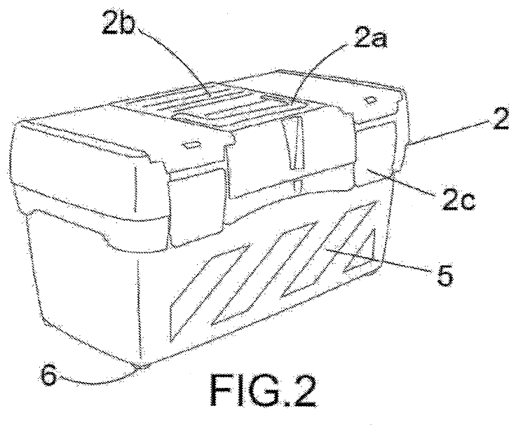

FIG. 3. Displays a view of the third body (3) as a component of the toolset carry-box with a luminescent surface.

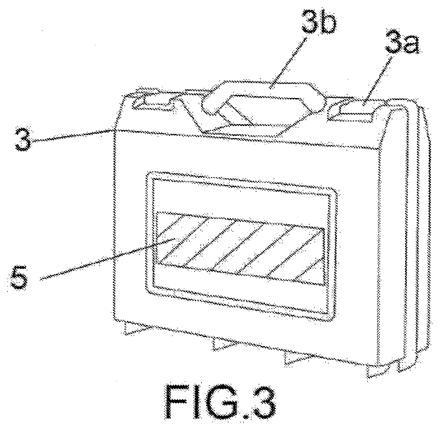

FIG. 4. Displays a view of the fourth body (4) as a component of the toolset carry-box with a luminescent surface.

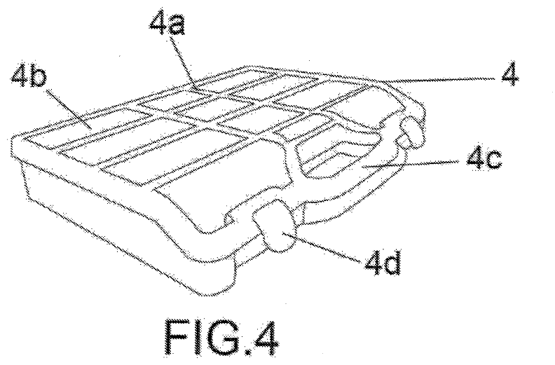

### OVERVIEW OF A DETAILED EMBODIMENT OF THE INVENTION

A favored embodiment of the invention is shown in the attached figures. More specifically, the toolbox fitted with a luminescent surface that forms the basis of this specification, is characterized in that it comprises a first body (1) that houses within it a second (2), third (3) and fourth (4) body, and where, the surface of these bodies (1, 2, 3, 4) has a luminescent and reflective coating (5) that allows for the viewing of said bodies (1, 2, 3, 4) even in situations of poor visibility. And whereby the bodies (2, 3, 4) will have a surface coinciding with the interior area of the first body (1) to be properly kept apart inside and in a safe way, thus avoiding possible movements.

The first body (1) has on its side dual wheels (1a) with a luminescent coating, which together with an ergonomic telescopic handle (1b) located on the side opposite the wheels (1a), allows said body to be positioned (1) upright, in order to carry the toolbox comfortably.

On its upper part, the body (1) has a non-slip surface (1c) that facilitates the placement of various elements on said surface (1c) safely. Furthermore, it features a series of luminescent material safety locks (1d) that prevent accidental opening of the body (1), thus increasing its safety features. Finally, the axes of the body (1) will be made of a metallic material resistant to various loads, allowing for versatile use in any workplace.

In a particular embodiment, the cover (1e) of the body (1) will incorporate a tape measure in both millimeters and inches that will serve to facilitate the operator in their tasks.

Likewise, in a non-limiting embodiment, the wheels (1a), with a luminescent coating, will be made of high-safety rubber or another material with equivalent mechanical characteristics.

The second body (2), will have in its upper part, a handle (2a) wholly devised in a luminescent material, and a non-slip surface (2b) that will prevent any object from sliding on its surface. Likewise, it will incorporate safety closures made of luminescent material (2c) that will prevent the accidental opening of the same.

The third body (3) will be specially designed for use as a power tool housing, and therefore, it will have a protective foam coating inside, which will serve to ensure that the aforementioned power tool is correctly stored, thus increasing its working life.

In a particular embodiment, the third body (3) will incorporate safety closures made of luminescent material (3a) that will prevent the accidental opening of said third body (3), and a handle (3b) to facilitate its transportation.

The fourth body (4) will have a transparent upper surface, which will allow for its contents to be viewed so as to locate the small objects stored inside.

Alongside the foregoing, a series of luminescent dividers (4a) will be fitted that split its interior into small housings (4b) and which, in turn, will make it easier to locate them.

In a preferred embodiment, the fourth body (4) will incorporate a handle (4c) and safety closures made of luminescent material (4d) to prevent accidental opening.

Finally, the bodies (1 and 2) come fitted on the under-section and bodies (3 and 4) on their lateral support part, with rubber plugs (6) or another material with equivalent mechanical characteristics, which improve their grip on the surface on which they are placed.

What is claimed is:

1-9. (canceled)

10. Luminescent surface toolbox comprising:
a first body,
a second body, a third body and fourth body housed inside the first body,
wherein an outer surface of these first through fourth bodies features a luminescent and reflective coating that allows for viewing of said first through fourth bodies in situations of poor visibility, and
wherein the second through fourth bodies feature a surface area having measurements which coincide with an interior area of the first body to be properly housed therein,
wherein the first body includes:
a non-slip surface in an upper part thereof,
a series of safety closures made from luminescent materials that prevent accidental opening of the first body and
axles made of a metallic material resistant to diverse loads;
wherein the second body includes:
a fitted handle made entirely from a luminescent material on an upper part of the second body,
a non-slip surface, and
safety closures of luminescent material that prevent accidental opening thereof;
wherein the third body includes:
a protective foam coating inside,
a series of safety locks manufactured from luminescent material that will prevent accidental opening of said third body and
a handle to facilitate transportation of the third body; and
wherein the fourth body includes:
a transparent upper surface,
a handle,
safety closures made of a luminescent material to prevent accidental opening of the fourth body, and
a series of luminescent dividers that divides an interior of the fourth body into small housings.

11. Luminescent surface toolbox according to claim 10, wherein the first body further includes:
two wheels with a luminescent coating on one side, and
an ergonomic telescopic handle located on a side opposite the wheels to allow for said first body to be positioned upright, and to be transported comfortably.

12. Luminescent surface toolbox according to claim 10, wherein the first body has a cover incorporating a tape measure in both millimeters and inches.

13. Luminescent surface toolbox according to claim 11, wherein the wheels are made of one of:
a high-safety rubber or
another material with equivalent mechanical characteristics to the high-safety rubber.

14. Luminescent surface toolbox according to claim 10, wherein the first and second bodies include on an under-section thereof and the third and fourth bodies include on a lateral support part thereof, one of:
rubber pegs or
another material with equivalent mechanical characteristics to the rubber pegs,
which improve their grip on the surface on which they are placed.
